(19) United States
(12) Patent Application Publication
(10) Pub. No.: US 2006/0208570 A1
(43) Pub. Date: Sep. 21, 2006

(54) System and method for automating power generation, propulsion and use management

(75) Inventors: Andrew J. Christian, Gainesville, FL (US); R. Alex Pesiridis, Clearwater, FL (US)

Correspondence Address: NUTTER MCCLENNEN & FISH LLP, WORLD TRADE CENTER WEST, 155 SEAPORT BOULEVARD, BOSTON, MA, 02210-2604, US

(73) Assignee: SOLOMON TECHNOLOGIES, INC., Tarpon Springs, FL (US)

(21) Appl. No.: 11/372,735

(22) Filed: Mar. 10, 2006

Related U.S. Application Data
(60) Provisional application No. 60/660,659, filed on Mar. 11, 2005.

(51) Int. Cl. B60L 1/00

(52) U.S. Cl. 307/10.1

(57) ABSTRACT

An automated energy generating and energy using system is provided. The system includes at least one electric energy user, at least one electric energy source, and may also include at least one electric energy storage element. These elements are instrumented so that each electric energy user has a sensor for determining an amount of energy used, each electric energy source has a sensor for determining an amount of energy provided, and electric energy storage element has a sensor for determining an amount of energy available in the storage element. A controller is operatively connected to each energy source, energy storage element and sensor. The controller is configured to control a level of operation of the at least one source of energy based upon at least the amount of energy used and the amount of energy available in the storage element, if employed. In this way, an automated electrical energy system is provided.

### CROSS REFERENCE TO RELATED APPLICATION

This claims priority to U.S. Provisional Patent Application No. 60/660,659, filed on Mar. 11, 2005, and entitled “System for Automation for Power Generation, Propulsion and Use Management,” which application is incorporated herein by reference in its entirety.

### FIELD OF THE INVENTION

The invention relates generally to control of self-contained, autonomous energy producing and using systems and more specifically to the monitoring of system conditions and health and the automatic control and adjustment of component parameters to maintain proper energy levels and system health while providing for safety of the operation of such systems and provides a means to log events and periodically log conditions.

### BACKGROUND OF THE INVENTION

As mechanized systems, including propulsion systems, have become more sophisticated, logic controls have been employed to monitor and automatically adjust functions of such systems in order to better maintain their operation. To this point, these systems have largely been energy users, and, only on a limited basis, have they been energy producers, energy storers, or a combination thereof.

In an effort to provide more energy efficient systems and to overcome the disadvantages of the prior art, propulsion systems that employ a motor-generator have been developed. Under certain conditions, such motor-generators are capable not only of providing energy, but of producing regenerative energy. One such system can employ the Electric Wheel™ marketed by Solomon Technologies, Inc. of Tarpon Springs, Fla., the operation of which is generally described in U.S. Pat. No. 5,067,932 entitled “Dual-input Infinite-speed Integral Motor and Transmission device,” U.S. Pat. No. 5,575,730 entitled “Multiple-input Infinite-speed Integral Motor and Transmission Device,” and U.S. Pat. No. 5,851,162 entitled “System and Apparatus for a Multiple Input and Dual Output Electric Differential Motor Transmission Device,” each of which is hereby incorporated by reference. The Electric Wheel, or any motor, be it rotational, linear or other type of device, is capable of functioning as a generator when outside, kinetic or stored force is applied to the system. A set of tools, some manual and some automatic, are described in British Patent No. 472,472 “Improvements in Means for Controlling the Excitation of Dynamo Electric Machines,” some aspects of which are improved upon in PCT Patent Application Publication No. WO 2005/075234, entitled “Regenerative Motor Propulsion Systems,” which is also hereby incorporated by reference herein. The application of this technology is generally described in U.S. Pat. No. 5,863,228 entitled “Method and apparatus for propelling a marine vessel,” which is also hereby incorporated by reference herein.

Despite these advances, there are still no successful applications of vehicle/vessel autonomous position and attitude control to power generation/use management systems. As power consumption and systems health on autonomous vehicles/vessels containing complex multi-source/multi-use systems is of high concern, integrating health management and automatic systems control for the power management into the basic system becomes more important, but much of the prior art addresses only individual component control while little is successfully accomplished for control of the total system or to account for unique and special conditions that can exist in such total systems.

### SUMMARY OF THE INVENTION

The present invention includes methods, systems, and algorithms for an autonomous energy generating and energy using system that can enhance system monitoring, control, maintenance, efficiency, and safety. In one embodiment one or more energy sources are utilized along with one or more energy storage devices, all of these can be monitored and controlled by a logic control function which senses both system-internal and external conditions to provide for various desirable functions. The various system components can be arranged and connected in such a way that the logic control function can consider overall system condition and health and provide for a desirable system maintenance regiment while also providing for a means of logging periodic and special events.

An example of a system of the invention is a parallel-hybrid system employing one or more power production elements, but more usually two or more, that are used to provide for vessel propulsion and/or one or more energy electrical outputs, all being monitored and controlled by a digital computer or other logic processing system. This embodiment can provide for a completely autonomous vessel capable of generating its own energy from renewable and expendable sources, storing that energy and using it for propulsion, house/hotel/office building loads, and/or being available for supply to users outside the system such as to a power grid.

In one aspect, the invention provides an automated energy generating and energy using system. The system includes at least one electric energy user, at least one electric energy source, and at least one electric energy storage element. These elements are instrumented so that each electric energy user has a sensor for determining an amount of energy used, each electric energy source has a sensor for determining an amount of energy provided, and electric energy storage element has a sensor for determining an amount of energy available in the storage element. A controller is operatively connected to each energy source, energy storage element and sensor. The controller is configured to control a level of operation of the at least one source of energy based upon at least the amount of energy used and the amount of energy available in the storage element. In this way, an automated electrical energy system is provided.

A vehicle having an automated energy generating and energy using system is provided in a further aspect of the invention. The system includes at least one electric energy user, at least one electric energy source, and at least one electric energy storage element. In particular, the at least one electric energy user includes at least one electric motor that is used to propel the vehicle. These elements of the system are instrumented so that each electric energy user has a sensor for determining an amount of energy used, each electric energy source has a sensor for determining an amount of energy provided, and electric energy storage element has a sensor for determining an amount of energy available in the storage element. A controller is operatively connected to each energy source, energy storage element and sensor. The controller is configured to control a level of operation of the at least one source of energy based upon at least the amount of energy used and the amount of energy available in the storage element.

In a still further aspect of the invention, a method of controlling an automated energy generating and energy using system is provided. The system in which this method is applied has at least one electric energy user, at least one electric energy source, and at least one electric energy storage element. These elements are instrumented so that each electric energy user has a sensor for determining an amount of energy used, each electric energy source has a sensor for determining an amount of energy provided, and electric energy storage element has a sensor for determining an amount of energy available in the storage element. A controller is operatively connected to each energy source, energy storage element and sensor. The method includes querying by the controller of each energy user sensor to determine the amount of energy being used in the system, querying by the controller of each energy source sensor to determine the amount of energy being provided in the system, and querying by the controller of the storage element sensor to determine the amount of energy available in the storage element. The method further includes adjusting by the controller of a level of operation of at least one energy source based on the inputs.

In another aspect of the invention, an automated energy generating and energy using system for use in a vehicle is provided having at least one electric energy user, at least one energy source, and a controller. The energy user includes an electric motor for providing propulsion and a sensor for determining the amount of energy used. The energy source has a sensor for determining the amount of energy provided. The controller is operatively connected to each energy source and sensor and is configured to control a level of operation of the energy source based at least upon the amount of energy used. In specific embodiments of the invention, the system can further comprise a throttle configured to allow a user to control a level of operation of at least one energy user in the system. The throttle can include a sensor indicating the throttle position to the controller, and the controller can control a level of operation of at least one source of energy based upon at least the position of the throttle.

In further embodiments, the energy storage element can include one or more batteries and a battery charging unit. In these embodiments, the controller can control a level of operation of at least one energy source based upon the amount of energy being used or provided by the battery and the battery charging unit and the amount of energy available in the batteries. Where the energy sources include an on-demand, consumable energy source, controlling the level of operation of the energy source can include turning the on-demand, consumable energy source on and off. Still further, the system can include a plurality of electric energy sources and the controller can be configured to control a level of operation of the battery charger and each energy source to provide a bulk charge, an acceptance charge, and a float charge based upon the amount of energy available in the energy storage element.

Additionally, the controller can include a memory for storing historical inputs from the sensors and can be configured to provide adaptive control to controlling the level of operation of the sources of energy. Where the system includes a throttle configured to allow a user to control a level of operation of at least one energy user in the system and the throttle including a sensor indicating the throttle position to the controller, the controller can also control a level of operation of at least one energy user in the system by adjusting a position of the throttle, with the memory storing historical positions of the throttle and applying adaptive control to control position of the throttle.

Where the systems and method are applied to a vehicle, the vehicle can further includes a speed sensor that senses a speed of the vehicle and communicates a signal representative of the speed to the controller for the controller to use in controlling various aspects of the system. The controller can also operate so as to adjust the throttle to maintain a maximum efficient velocity of the vehicle, or to maintain a no-drag state of an electric motor that provides propulsion for the vehicle.

### BRIEF DESCRIPTION OF THE DRAWINGS

The invention will be more fully understood from the following detailed description taken in conjunction with the accompanying drawings:

FIG. 1 provides a diagram of a system of the invention illustrating a number of system elements and their communication channels;

FIG. 1A provides a state diagram illustrating a possible flow of events and reactions for the system of FIG. 1;

FIG. 2 illustrates an embodiment of the invention for general vessel energy management;

FIG. 2A provides a state diagram illustrating a possible flow of events and reactions for the system of FIG. 2.

FIG. 3 illustrates a system of the invention applied to a vehicle and capable of controlling the system for maximum efficient velocity behavior;

FIG. 4 illustrates a system of the invention in which charge regulation of a battery bank is provided;

FIG. 5 illustrates a system of the invention suitable to provide for no-charge, on-power mode;

FIG. 5A provides a state diagram illustrating a possible flow of events and reactions for the system of FIG. 5;

FIG. 6 illustrates a system of the invention suitable to provide for a maintaining head-way function; and

FIG. 7 illustrates a system of the invention suitable to provide for a no-rotation mode function.

### DETAILED DESCRIPTION OF THE INVENTION

This invention, among other objectives that are explained throughout this description, advances and improves upon PCT Patent Application Publication No. WO 2005/075234, entitled “Regenerative Motor Propulsion Systems” (incorporated herein by reference), focusing on greatly automating the system. That patent and this present invention primarily use examples of marine applications, but the skilled artisan can readily apply this technology to far more application. A few of the possible applications are listed, but are not limited to; water craft, land-based vehicles, aircraft, elevators, conveyors, heating and air conditioning equipment, pumps, machine tools, and space craft propulsion and inertial stabilization. One embodiment of this invention is presented in the attached figures. These depict an application of the invention to a marine sailing vessel.

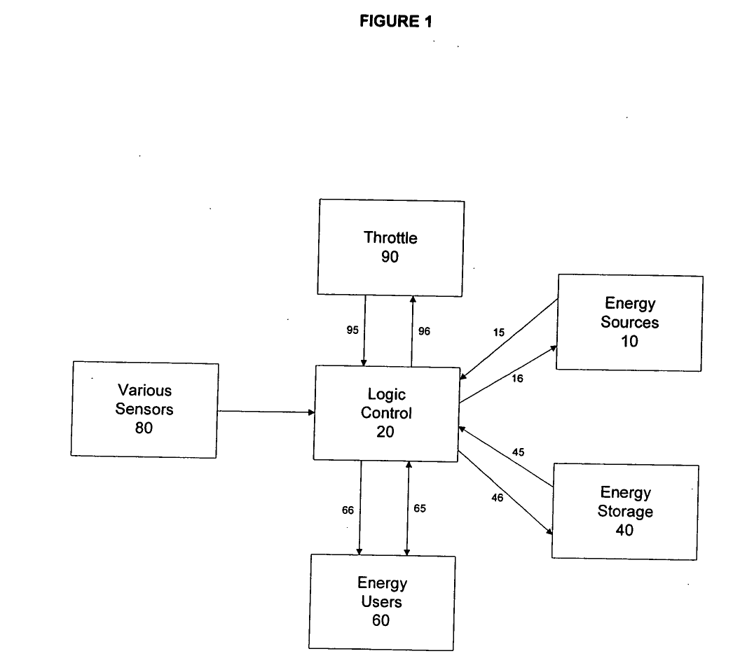

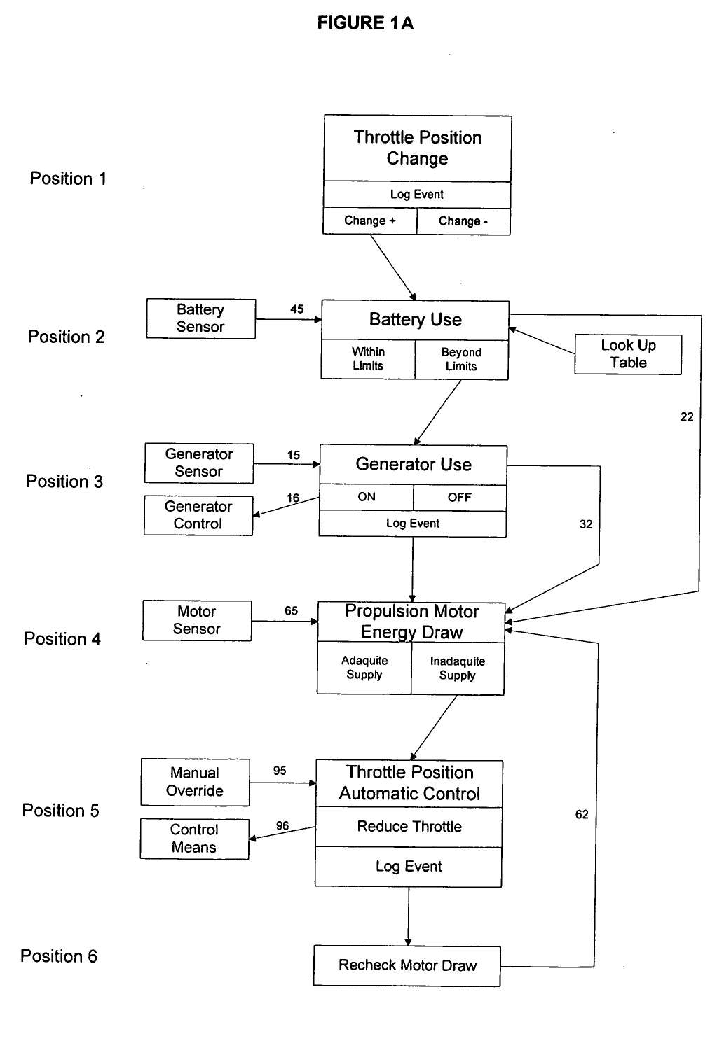

One illustrative embodiment of a system of the invention is shown in FIG. 1. This figure depicts various Energy Sources 10 with sensors 15 and control means 16, Energy Storage 40 with sensors 45 and control means 46, Energy Users 60 with sensors 65 and control means 66, additional Sensors 80, a Throttle 90 with sensors 95 and control means 96 and Logic Control means 20.

Energy Sources 10 can consist of renewable type such as solar panel and/or consumable type such as diesel generator or other fossil fuel based generator and can be multiples of either or one of these. Energy Sources 10 could also include the regeneration application of a motor/generator system such as the Electric Wheel. Sensors 15 can consist of both energy flow and Energy Sources health monitoring devices while control means 16 can provide for functions such as ON/OFF and energy flow regulation.

Energy Storage devices 40 can be any appropriate energy storage device such as battery banks, capacitors, flywheel and/or thermal sink or a combination thereof. In one embodiment, Energy Storage devices 40 comprise a battery bank including a plurality of batteries such as wet cell lead acid batteries or lithium ion batteries. Energy Storage device conditions are monitored by sensors 45 and may provide information on conditions such as charge level and battery temperature. Control means 46 can provide for connecting and disconnecting various Energy Storage Devices to various Energy Users.

Energy Users 60 can be propulsion systems, life support, navigation and/or communications or a combination thereof. Energy Users 60 can also include the propulsion or motor application of a motor/generator system such as the Electric Wheel. Energy Users are monitored by sensors 65 and may provide information such as energy flow levels and other operational conditions depending upon the individual device. Control means 66 can be utilized to adjust, for example electric motor throttle position or cabin temperature. Various Sensors 80 are generally associated with functions other than those previously mentioned and may monitor, for example vessel velocity and atmospheric conditions.

Throttle 90 is usually associated with a motor speed/direction throttle used to control the propulsion means. Sensors 95 would provide information about throttle position and perhaps rate-of-change of throttle position. Control means 96 can be utilized to adjust the throttle position automatically. Throttle 90 may be a manual throttle for controlling speed or it could be an electronic throttle implemented in Control Logic 20, or in a separate device in communication with Control Logic 20. Still further, Throttle 90 could include combinations of these elements or other elements that may be known to the person of ordinary skill in the art.

Logic Control 20 monitors all system parameters and conditions, compares these with levels set forth in lookup tables or other means and thru employment of a decision making means produces control commands which are then fed to the appropriate control means. Logic Control 20 may provide for a manual override means or this may be provided via the individual components of the embodiment. Logic Control may be made to provide visual, audio, vibrational or other indication for human or other monitoring of system conditions and control situations. Conditions and manual control could also be provided for via short or long distance wired or wireless communications. Logic Control can also be made to record system function and errors, providing for later trouble shooting or for adaptive learning.

An apparatus for carrying out the functions of Logic Control 20 (as well as the various Control means referenced herein) can be a general purpose computer, such as personal and workstation computers known in the art (as well as other types of general purpose digital computing devices having processors capable of executing instructions to carry out the desired functions) configured for use with the invention. Or, Logic Control functionality could be implemented by a special purpose digital computing device, for example an embedded digital processor, designed for operation within the scope of the present invention. This apparatus can also be referred to herein as a controller or a processor. It should be understood that the present invention is not limited to use with any particular computer platform, processor, or programming language as aspects of the present invention may be implemented in software, hardware, firmware, or a combination of the three. Instructions for carrying out Logic Control 20 may be implemented as a computer program product tangibly embodied in a machine-readable storage device for execution by a computer processor. Indeed, various steps of embodiments of the invention may be performed by a computer processor executing a program (i.e., software or firmware) tangibly embodied on a computer-readable medium to perform functions by operating on input and generating output. The computer-readable medium may be, for example, a memory in a computer or a transportable medium such as a compact disk, a floppy disk, or a diskette, such that a computer program embodying the aspects of the present invention can be loaded onto any computer. Logic Control 20 could also be implemented or augmented remotely using a wired or wireless interface to the system of FIG. 1 or other embodiments of the invention. In one specific embodiment, Logic Control 20 is implemented on a general purpose computer using the LabView graphical development environment available from National Instrument Corporation of Dallas, Tex. in conjunction with a data acquisition and control card (also available from National Instruments Corp.) to monitor and control the elements of the system.

Referring now to FIG. 1A, an example method or process flow for the system of FIG. 1 will be described. FIG. 1A depicts a possible set of conditions, logic flow and system outcome for the embodiment depicted in FIG. 1 in terms of “positions” that can be states, points in time, or locations on a path through a decision tree. While one particular path through the states is described in detail, a person of ordinary skill will recognize that other paths through the illustrated states can be followed. Automated functions in this example are carried out by Logic Control 20 of FIG. 1. At position 1, Manual Control throttle 90 is changed to increase velocity of Electric Motor 60 (an exemplary Energy User 60 from FIG. 1). The event is logged and is determined to be a change that requires more energy. At this time the Battery Bank 40 (an exemplary Energy Storage 40 from FIG. 1) is the only energy supplier employed. At position 2, Battery use is determined by looking at Battery Sensor 45, and the Battery use is compared with levels and associated response actions in Lookup Table. Battery use may be determined to be beyond a threshold level, wherein the conditions are logged and flow moves to position 3.

For this example, a diesel generator is employed as auxiliary power in Energy Sources 10 of FIG. 1. At position 3 the generator is brought online via control 16 and its conditions are monitored by sensors 15, and events and conditions are logged. At position 4 energy draw by propulsion motor 60 is monitored via sensors 65. This is compared with Battery conditions via communication 22 and generator conditions via communication 32. Where it is determined that the combined energy being provided by the Battery Bank and the Generator is inadequate to achieve the velocity required by the present throttle setting, and the flow moves to position 5. At position 5 the throttle automatic control can reduce the throttle position and the logic process loops via pathway 62 at position 6 back to position 4 for continual monitoring. A Manual Override can be provided for situations that demand system operation beyond the programmed norm.

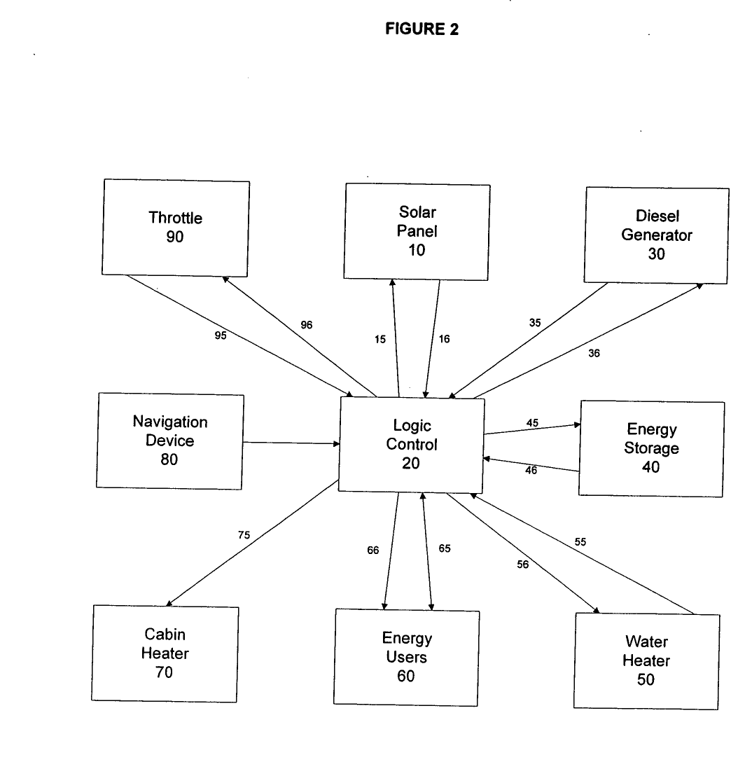

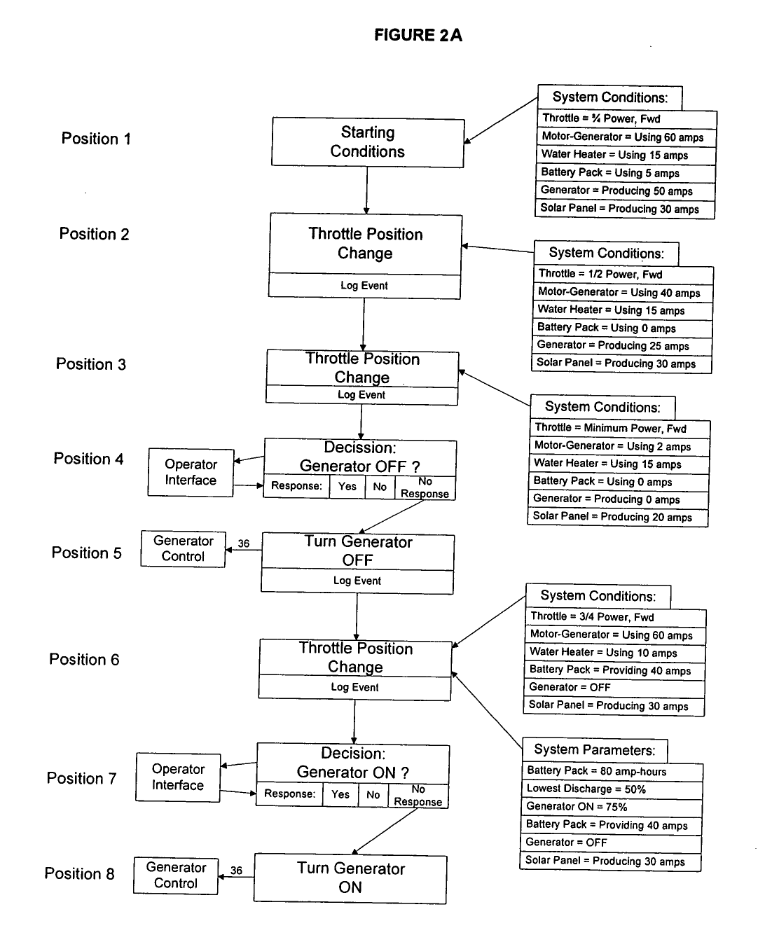

A further embodiment of the invention, an embodiment well suited for use, for example, on a sailing vessel, is depicted in FIG. 2. One reason this embodiment is useful for such an application is the invention's inherent ability to function completely autonomously, requiring only renewable energy input sources and providing for all its own monitoring and control, with little or no manual control required. In this embodiment, a Solar Panel array 10 represents a renewable and periodically-available power source. Diesel Generator 30 represents a nonrenewable, on demand power source and is capable of producing both electrical and heat energy. Motor-Generator 60 functions both as a propulsion device and an energy source, when a device such as the Electric Wheel or a regenerative-capable motor-generator is utilized. The motor-generator can become an energy source when the sailing vessel is being propelled by its sails and water pressure causes a propeller to rotate the motor-generator shaft. Energy from Sources 10, 30 and 60 can be stored in Battery Pack 40 and Water Heater 50. Energy is used by Motor-Generator 60, when functioning purely as a motor, and by Cabin Heater 65. Navigation device 80, which can include a GPS receiver as well as other instruments, can provide information such as vessel position and speed. The Throttle 90 provides for operator input of desired vessel speed.

Logic Control 20 is here represented by a matrix of programmable logic algorithms for various anticipated system requirements and a recording function to allow for adaptive learning and control, whereby Logic Control 20 learns the changing conditions and/or human operator input over time and adapts the control of the elements of the system based on this history. It is Logic Control 20 that monitors energy needs (in the examples below, this occurs generally by monitoring current draws by the various loads), as well as the stored energy and current available from energy sources to regulate the production and use of energy on the vehicle. The use of adaptive control in dynamic systems having human operators is known in the art and can be seen, for example, in U.S. Pat. No. 5,555,495 to Bell et al., entitled “Method for adaptive control of human-machine systems employing disturbance response,” which patent is hereby incorporated by reference. A number of adaptive control techniques are also described in “Robust Adaptive Control” by Petros A. Ioannou and Jing Sun, published by Prentiss Hall in 1996 (ISBN: 0-13-439100-4), also incorporated herein by reference. The present invention includes the application of these techniques to the control of the systems described herein using Logic Control 20 to implement them.

FIG. 2A depicts a possible set of conditions and series of events with resulting system responses, with reference to the system of FIG. 2. As with FIG. 1A, while one particular path through the states is described in detail, a person of ordinary skill will recognize that other paths through the illustrated states can be followed. At Position 1 the starting conditions are noted as: Throttle 90 in ¾ power forward position, Motor-Generator 60 using 60 amps, Water Heater 50 using 15 amps, Battery Pack 40 charging and using 5 amps, Diesel Generator 30 running and producing 50 amps, and Solar Panels 10 producing 30 amps. The total current draw of the 60 amps being used by the Motor-Generator 60, the 15 amps being used by the Water Heater 50 and the 5 amps being used by the Battery Pack 40 comes to 80 amps. The total current drawn is the same as the total of what is being produced by the Diesel Generator 30 (50 amps) and what is being produced by the Solar panels 10 (30 amps), no system adjustments are needed in this state. In this case, Logic Control 20 continuously monitors the system conditions, sampling the various sensors at a rate of, for example, 100 times a second, making periodic log entries, for example once every minute.

At position 2 of FIG. 2A, the Throttle 90 is moved to reduce vessel speed to ½ power. Logic Control 20 also notes the following conditions on this sensor sampling cycle: Motor-Generator 60 using 40 amps, Water Heater 50 using 15 amps, Battery Pack 40 fully charged and using 0 amps, Diesel Generator 30 running and producing 25 amps, and Solar Panels 10 producing 30 amps. Because the Diesel Generator is capable of regulating itself (i.e., it includes its own “smart” controller that conforms the generator's operating characteristics to the load placed upon it), the amp usage for the system is balanced. Logic Control 20 logs this event and no other change is needed.

At position 3 of FIG. 2A, the Throttle 90 is moved to reduce vessel speed to minimum. Logic Control 20 also notes the following conditions on this sensor sampling cycle: Motor-Generator 60 using 2 amps, Water Heater 50 using 15 amps, Battery Pack 40 fully charged and using 0 amps, Diesel Generator 30 running and producing 0 amps, and Solar Panels 10 capable of producing 30 amps but being regulated to 20 amps. Because the Solar Panels are capable of supplying all amperage needed by the complete system, it may no longer be necessary to run the Diesel Generator.

At position 4 of FIG. 2A, Logic Control 20 presents a message to the operator via, for example a graphic display at the helm station asking if the operator will be leaving the vessel in the low power condition and if Logic Control 20 should turn the Diesel Generator 30 OFF, and that if no response is received within 60 seconds Logic Control will assume the Diesel Generator is indeed no longer required and will turn it OFF. Sixty seconds pass and no response is received therefore at position 5 Logic Control 20 turns Diesel Generator 30 OFF via control device 36.

At position 6 of FIG. 2A, the next change is noted, which is an increase of the Throttle 90 to ¾ power. Logic Control 20 also notes the following conditions on this sensor sampling cycle: Motor-Generator 60 using 60 amps, Water Heater 50 using 10 amps, Battery Pack 40 providing 40 amps, Diesel Generator 90 not running, and Solar Panels 10 producing 30 amps. Logic Control 20 consults the System Parameters table for the Battery Pack 40 capacity. The total capacity is 80 amp-hours. System Parameters are currently set to only allow 50% of this capacity be used. System Parameters are also currently set to instruct Logic Control 20 to turn the Diesel Generator 30 on when Battery Pack reaches 75% capacity. Logic Control 20 calculates that at the present draw, the Battery Pack will reach 75% capacity in 30 minutes.

At position 7 of FIG. 2A, Logic Control 20 presents a message to the operator stating that given the current rate of energy demand the Diesel Generator 90 will be activated in 30 minutes and provides the operator with a selection to override this automatic function. If 30 minutes pass and no response is received, at position 8 Logic Control 20 turns the Diesel Generator 30 ON via control device 36.

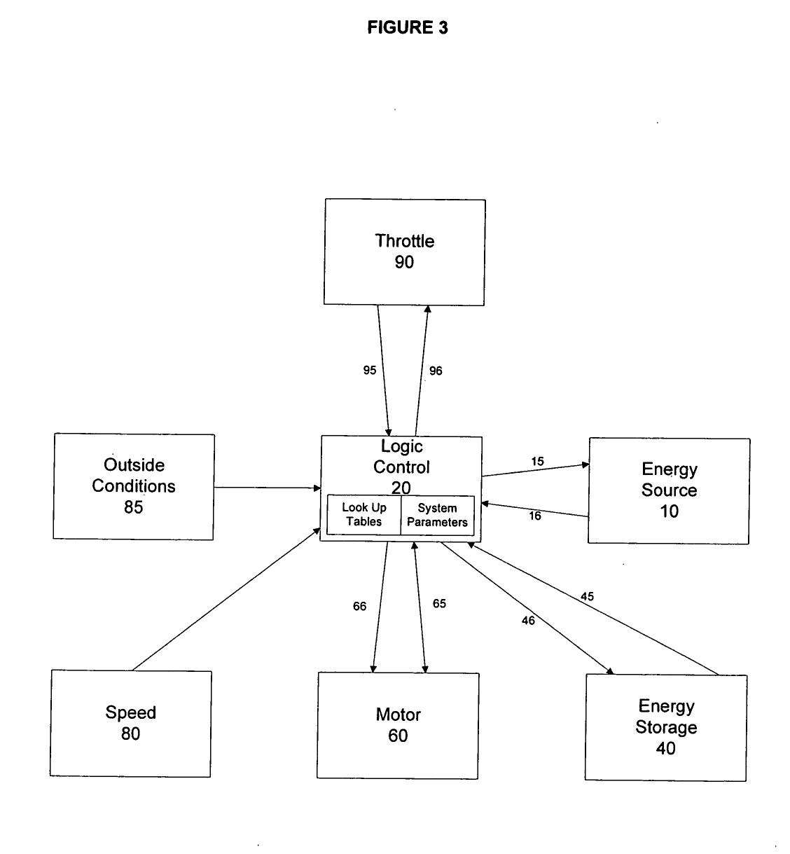

A further embodiment of the invention, related to the embodiments of FIGS. 1 and 2 but including further elements, is depicted in FIG. 3. The system of FIG. 3 is configured to provide one embodiment of optimal energy use. In the case of a sailboat or water craft, and in reality for nearly any vehicle or application, there is a range of speed/velocity wherein the vehicle/vessel is operating at a point at or near the maximum velocity while at the same time most efficiently utilizing energy input. In the case of a sail boat this is generally considered the hull-speed for the vessel. As the sailboat approaches its particular hull-speed, thru increasing application of throttle, the vessels speed levels out. Beyond this point increased throttle and resulting increased energy draw will produce only marginal, if any, additional vessel velocity. It is this position on the throttle and energy use setting that delivers the maximum velocity for the most economical energy use, and is an extremely desirable setting to maintain. This velocity is referred to herein as the Maximum Efficient Velocity or MEV. However, constantly changing sea conditions such as waves and wind, would require the constant and vigilant attention of the operator in a manually controlled system. The embodiment depicted in FIG. 3 provides a system for automating this function.

Throttle 90, being either a manually actuated lever that produces a variable analog or digital output signal, or a set of one or more buttons (or soft buttons associated with a display) with assigned functions such as, but not limited to: stop, go, maximum efficient speed, maximum system speed—provides user activated system inputs that are monitored by Logic Control 20. Energy Source 10 in this embodiment can be a diesel generator. Energy Storage device 40 can be a battery pack. Vessel propulsion is provided by Motor 60. Speed sensor 80 can be of the paddle-wheel type commonly found on sailboats, or can be derived from GPS information. Outside Conditions 85 can be wind, wave or other sensors that provide information necessary for proper handling of the vessel.

Operation of the system depicted in FIG. 3 could be activated by pressing a button at the helm station labeled “MEV” (Maximum Efficient Velocity). Logic Control 20 receives the signal that the MEV button has been activated. Using an adaptive learning technique, Logic Control 20 queries a lookup table for past general settings corresponding to the MEV condition. Logic Control 20 also queries the System Parameters to find a formula associated with the starting point for running the MEV routine. The formula might instruct Logic Control to take the average of the historic MEV amp draws, subtract a percentage and use this as the starting point for this present MEV routine. Logic Control then instructs Automatic Throttle Control 96 to move, at a predetermined rate, to the indicated position.

At this point Logic Control will continue to monitor vessel speed and motor amp draw. Small adjustments to the Automatic Throttle Control will be related to the corresponding results on vessel speed and motor amp draw. Results will be logged and referred to. If a small increase in Throttle position results in minimal or no increase in vessel speed, the Throttle will be returned to its previous lower position. Alternatively, if the vessel speed increases, the Throttle will stay at the new higher position and further variation in Throttle position will be tested from this new baseline position. If a small decrease in Throttle position results in minimal or no decrease Motor amp draw, the Throttle will be returned to its previous higher position. These routines can be varied depending on the sensitivity of the system and components

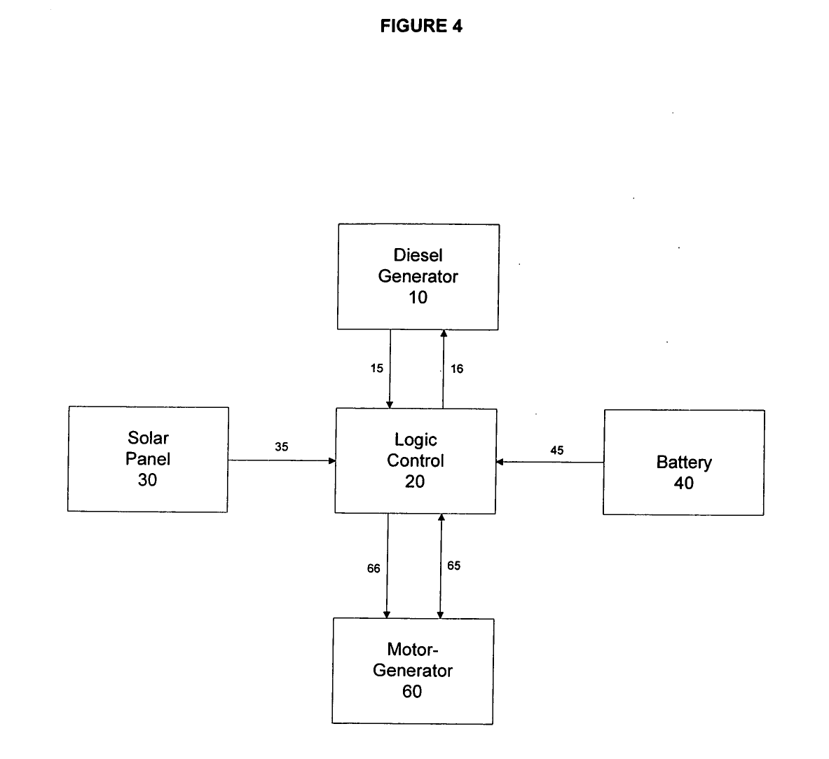

A further embodiment of the invention is depicted in system of FIG. 4 relating to a charge regulation algorithm for a battery bank. Three energy sources are utilized in explaining this embodiment, though the skilled artisan will readily recognize that more, fewer or different energy sources could be applied. Energy storage batteries require that a proper charge regime be applied for proper maintenance of the batteries, to provide for most efficient energy storage, and to provide for maximum battery life. This function is quite often provided for by the use of a “smart” three-step battery charger that, in the case of a sailing vessel, is powered by a shore power circuit when the vessel is tied up at the dock. However, while the vessel is underway shore power is not available and it may be advantageous to be able to provide for this charging function through other means. This embodiment provides this functionality through the use of one or more energy source, one or more Logic Controls 20 and various sensors.

A proper charge regime in a smart three-step battery charger consists of a combination of pre-programmed instructions that are selected for each individual type of battery depending on battery type, manufacturer and possibly other parameters. As a general description of how the three steps operate, a common AGM (absorbed glass mat) lead-acid battery is used. Each type of battery; AGM, Gel-cell, lithium-ion, etc. would require different settings and would be programmable into the Logic Control 20 for the particular battery type utilized. When the battery bank requires charging the first step is to provide a Bulk charge. During this phase the charging device provides an increasing-with-respect-to-time voltage to the battery bank that will allow the battery bank to receive the maximum allowable, by preset parameters, current amount. When a preset voltage is arrived at, the charging device switches to the Acceptance charge stage. During this stage the preset voltage is maintained and the battery bank is allowed to receive what current it will. This current level will naturally decrease with respect to time. When the current level has fallen to a point corresponding to a preset level the charger will enter the final stage, Float charge. At this point the voltage is lowered to a preset level and the battery bank will continue to draw an ever decreasing level of current. This charge regime can be considered analogous to filling a water tank with a garden hose. When the tank is empty the velocity of the hose is increased to a point that allows water to flow in as fast as possible without causing so much turbulence that water is ejected from the tank. The hose is then maintained at this velocity until such time that the tank is nearing full. The velocity of the hose is then tapered off to allow water to flow in more slowly and allow the tank to become completely full without ejecting any water from the tank. In reality Logic Control 20 could perform this exact function if it were for some reason required.

In one embodiment of FIG. 4, Logic Control 20 can contain a set of preset instructions for type, size and manufacturer of the Battery Bank 40 installed. These instructions would contain a battery level at which Logic Control 20 would be instructed to start a charge cycle due to Battery Bank 40 having reached a certain level of discharge. For this embodiment we will examine how a system consisting of only Diesel Generator 10 would function. Using Sensor 45, Logic Control 20 can poll Sensor 45 on the current level of discharge for the Battery Bank 40 and compare the information supplied by Sensor 45 with information contained in a lookup table. When a pre-assigned level of discharge is reached, Logic Control 20 would instruct Diesel Generator 10 to start. As energy flows from Diesel Generator 10 into Battery Bank 40, Logic Control 20 can monitor Generator output thru Sensor 15 and Battery Bank state thru Sensor 45 and further compare these with information in a lookup table. Logic Control 20 can cause Generator 10 to adjust its output to correspond with the correct parameters prescribed in the lookup table. The Sensors 15 and 45 may be, but are not limited to, voltage sensors, amperage sensors and/or temperature sensors. As preset levels of input from Sensor 45 are reached, Logic Control 20 will adjust Generator 10 to provide the needed levels of energy to provide the proper Bulk, Acceptance and Float charge regimes.

It is recognized that in most cases a Diesel Generator is not appropriate to provide a proper Float charge cycle as this cycle usually takes several hours of very low level energy. A Diesel Generator running at very low levels for long periods of time is not only impractical, but also damaging to the diesel engine. For this reason it would be advantageous to employ a second source of energy, perhaps a bank of one or more Solar Panels 30. Solar Panels 30 can provide a low level of energy for an extended period of time, provided sunlight is available. It is also recognized that other sources of low-level energy can be made available, such as, but not limited to, wind generators, Motor-Generator 60, human or animal treadmills, and thermal energy transducers utilizing bio-mass digestion.

In this embodiment, when Logic Control 20 recognizes that the charge state of Battery Bank 40 has reached the point where it should switch to Float charge, Logic Control 20 can instruct Diesel Generator 10 to turn off and will then instruct Solar Panel 30 to provide energy to Battery Bank 40. Solar Panel 30 output will be monitored thru Sensor 35 and compared with information from Sensor 45 and information in a lookup table so that Logic Control 20 can provide a proper Float charge regime to Battery Bank 40.

In another embodiment of FIG. 4, one that is quite advantageous to a sailing vessel, a Motor-Generator 60 is employed. This device can be made to function as either a Motor to provide propulsive energy to motivate the vessel, or as a generator while sailing in favorable conditions to produce energy. The Motor-Generator produces energy when the vessel is sailing and/or when surfing down a wave front, or when anchored in a high current area. The skilled artisan will recognize that many other utilizations of this concept can be applied when working with land-based vehicles and devices as well as with machine tools and even space craft. In this embodiment a sailing vessel is sailing under wind power in ever changing sea and wind conditions. The vessel's propeller is made to turn by the application of water pressure exerted by the motion of the vessel thru the water. The propeller shaft in turn rotates the Motor-Generator 60 shaft causing the Generator function to produce energy. In order for Logic Control 20 to maintain a proper charge regime to Battery Bank 40, in constantly changing sea and wind conditions, moment-by-moment sensor inputs must be received and compared with each other and with information in lookup tables. The output from Motor-Generator 60 is controlled by use of biasing the throttle, either electronically or mechanically, possibly, but not limited to, thru control scenarios described in PCT Patent Application Publication No. WO 2005/075234, entitled “Regenerative Motor Propulsion Systems,” which has been incorporated by reference above. One possible scheme for controlling this biasing is by advancing an electronic throttle to increase the motoring function and thereby decreasing the generating function and using a reverse application to decrease the generating function.

During the Bulk charge phase of the three-step charge, the Motor-Generator 60 would be biased so as to provide maximum energy output, providing maximum energy input to Battery Bank 40. Logic Control 20 would monitor Sensors 65 and 45 and compare their information with information contained in lookup tables to maintain the proper charge regime. The electronic throttle biasing of the Motor-Generator 60 will be changed as the information gathered from Sensor 45 indicates, thru comparison with information in lookup tables that the charge schedule should move into the Acceptance phase of charge. Similarly the charge regime will again change when Sensors indicate levels have reached preprogrammed information levels in lookup tables and Logic Control 20 will maintain the proper levels all while the vessel is operating in ever changing sea and air conditions.

As the Float stage progresses, when utilizing the Motor-Generator 60 as the charging device, the Logic Control 20 will continue to electronically advance the bias on the throttle to cause the Motor-Generator 60 to eventually reach a point where very little energy is being produced. At the point where the Motor-Generator 60 is no longer producing any energy but at the same time is not using any energy, is a special situation. When this situation is constantly maintained, on a moment-by-moment basis, by the Logic Control 20, it can provide significant, advantageous ramifications. Not only can this level of control provide for the end of a precisely monitored and controlled charge regime, providing proper maintenance of the storage medium, but it can also provide for no-drag sailing and, most importantly, for safety of the vessel and its occupants.

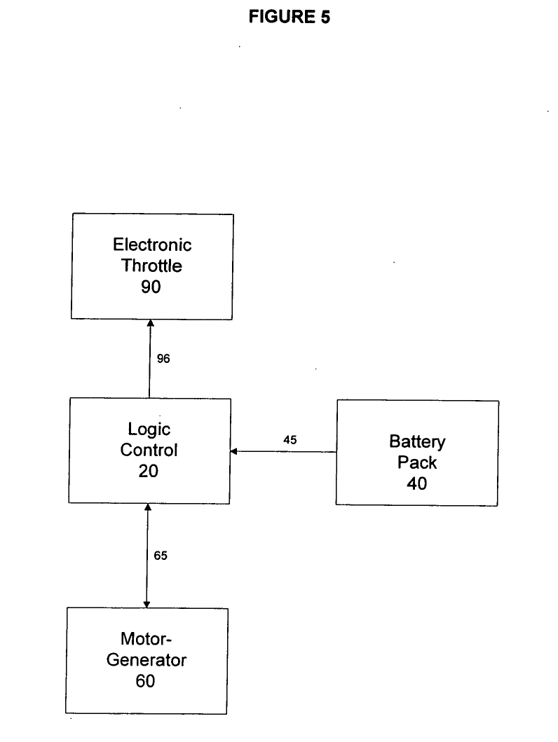

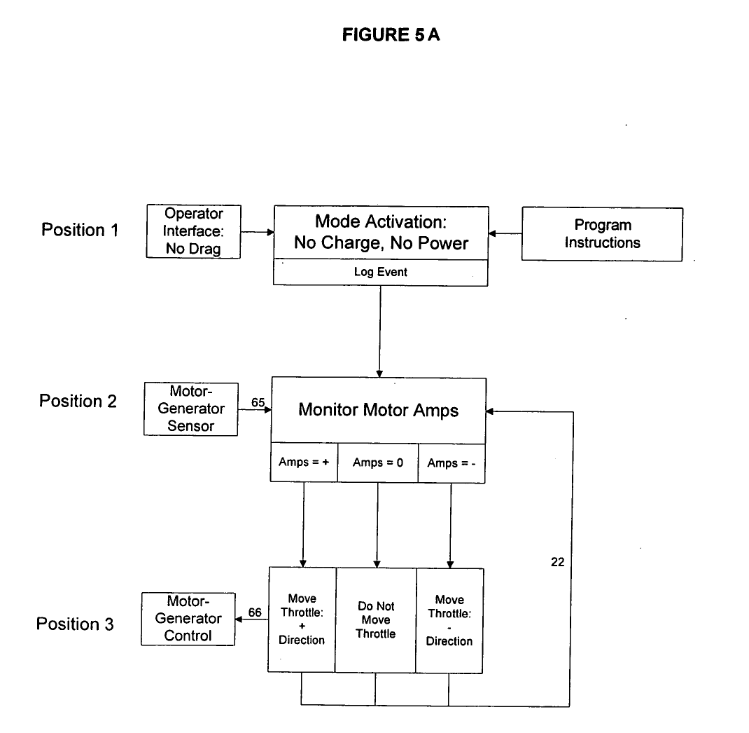

Expanding on this situation, FIG. 5 depicts an embodiment of the invention that provides for a No-Charge, No-Power mode of operation. In describing this embodiment, only Logic Control 20, Battery Bank 40, Motor-Generator 60 and associated Sensors 45 and 65 are illustrated. A skilled artisan can readily appreciate that additional energy inputs and energy storage devices can be applied and that the present application to a sailboat can be expanded to include many types of vehicles, vessels and devices. In this embodiment a sailboat is employed mainly because it provides for a readily understandable scenario. When purely sailing under wind power it is desirable to have as little drag applied to the vessel as possible. When a motor of any type is installed for auxiliary power, the propeller sitting in the water while the motor is not in use can exert a drag situation and cause the vessel to sail slower than it would if the propeller were removed from the situation. Unfortunately it is not an easy matter to simply remove the propeller. For this reason various schemes have been devised to come close to accomplishing this no-drag situation. One of these is to employ a folding or feathering propeller. These can streamline themselves when power is removed from the shaft, as in turning the motor off. In the case of a Motor-Generator a folding propeller is not particle as there is no way to keep the paddles open during generation mode. However some feathering propellers can be made to stay open by briefly applying a reverse energy burst.

But utilizing a Logic Control system and a Motor-Generator, none of these special devices are necessary, and a usually less expensive standard fixed-blade propeller can be utilized. Logic Control 20 can monitor current in and out of Motor-Generator 60 via Sensor 65 and the current flowing in or out of Battery Bank 40 via current sensor 45. Logic Control 20 can also adjust the Electronic Throttle 90 via Electronic Control 96 to the position where energy is neither being used or produced by the Motor-Generator 60. Logic Control 20 makes moment-by-moment adjustments to the Electronic Throttle 90 to maintain this No-Charge, No-Power mode, thereby accounting for ever changing conditions of seas and air. In this situation a very minimal amount of energy is taken from or delivered to the Battery Bank 40 with the net being essentially zero, but the propeller appears to disappear in the water and causes no drag, thereby allowing the sailboat to function purely as a sailboat. This eliminates the need for any special, expensive propeller and eliminates the need for any human intervention, which in order to maintain the same level of control would require constant intervention by the operator thru continuous adjustment of a manual throttle.

FIG. 5A depicts the logic flow for the No-Charge, No-Power mode for the system of FIG. 5. At Position 1, an Operator Interface, for example a button labeled “No Drag” is activated. Logic Control 20 loads instructions for the No-Charge No-Power mode. At position 2 Logic Control 20 monitors the current in/out of the Motor-Generator 60 via Sensor 65. As the sailboat accelerates down a wave, the Motor-Generator 60 produces energy and a level of positive amps is reported to Logic Control via Sensor 65. As the sailboat climbs up a wave the Motor-Generator uses energy as the Motor attempts to maintain the velocity setting of the Throttle and a level of negative amps is reported to Logic Control via Sensor 65. At points between these up-wave and down-wave conditions Sensor 65 will report zero amps.

At Position 3, actions for the three possible situations are executed. If positive current flow was reported, the instructions indicate that Electronic Throttle 96 be moved in a positive direction. If negative current flow was reported, the instructions indicate that Electronic Throttle 96 be moved in a negative direction. If zero amps were reported the instructions indicate that Electronic Throttle not be changed. At this point the control routine loops, via path 22, back to Position 2 providing for a continuous monitoring and adjusting of the system.

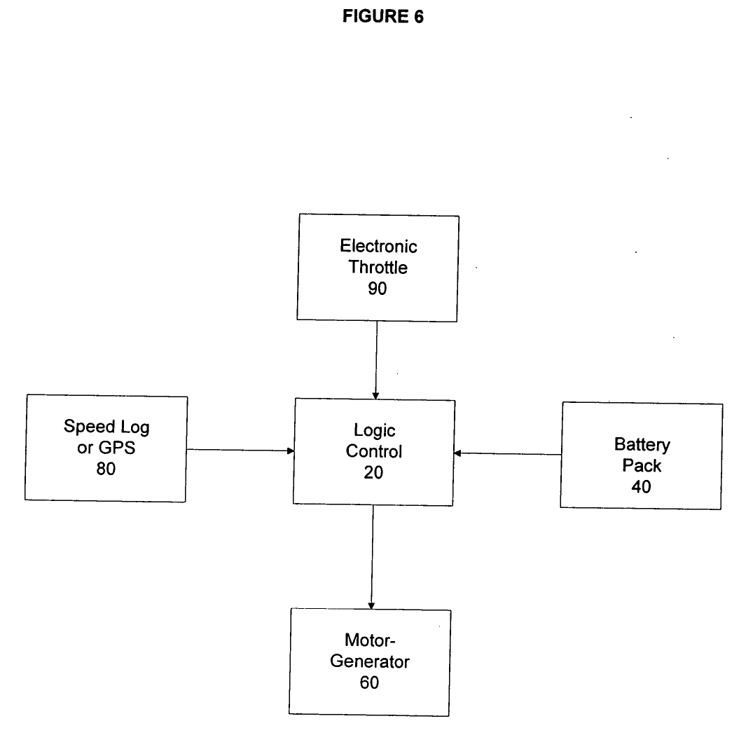

Further features applicable to this aspect of the invention can be described by reference to FIG. 6 and can be referred to as the Maintain Headway mode. As a particular example of this embodiment, when sailing it is quite often more advantageous to sail in a slightly different direction than the preferred heading to take best advantage of the prevailing winds. This will quite often require the sailor to employ what is termed a “tack,” where the vessel sails a zigzag pattern back and forth across the preferred (rhomb) line direction. When the vessel changes from one tack to the next, it passes thru the head-on wind and in many cases the vessel speed falls off drastically. It would be desirable to in some way maintain the vessel velocity thru the tack, but with a conventionally diesel powered vessel this would require starting the engine before each tack, allowing it to warm up, using it briefly during the tack and then turning it off, only to have to start it again for the next tack. One could also simply leave the engine running all the time, but this would waste fuel and cause undue wear on the engine as most diesel engines do not respond well to sitting at idle for long periods of time. Even in the case of a manually controlled electric powered vessel, the proper biasing of the throttle would require considerable human input during a time when the operator already has his hands full handling sail control lines and the steering tiller and much energy would be wasted from the resulting human error.

In the following description, the invention is applied to a sailboat, but the skilled artisan will readily see other applications that could benefit equally or even more from these algorithms. In this embodiment the sailboat is being sailed on a tack and the operator has adjusted the sails and tiller to best utilize the available wind relative to the direction the operator wishes to proceed. The operator activates a switch on the Electronic Throttle 90 that is, for example, labeled MH (maintain headway). This sends a signal to Logic Control 20 instructing Logic Control to record the vessel velocity input from Speed Log or GPS 80 into a table. Logic Control 20 continually monitors the input from Speed Log or GPS 80 and if in comparing this information with that recorded it notices a decrease in vessel velocity it in turn sends a signal to Motor-Generator 60 causing it to increase the vessel velocity to the recorded, desired speed.

This becomes especially advantageous when the operator takes the vessel thru a tack and the vessel speed would normally fall off. Instead Logic Control 20 causes the vessel to Maintain Headway by applying energy to Motor-Generator 60. A special case for this embodiment could also be realized when the vessel is sailing up and down waves. As the vessel sails up a wave energy is applied to the Motor-Generator to maintain vessel headway. As the vessel sails down the wave the vessel tries to accelerate and the Motor-Generator 60 switches to generator mode and puts energy back into the Battery Bank 40. In this manner the vessel can realize an over-all benefit by maintaining headway thru the use of energy to accelerate and producing energy from excess speed when the vessel is accelerating.

The accuracy of this process can be varied by means of system clock speed. Further refinements to the system can be accomplished by use of adaptive learning whereby, for example, the time between positive and negative swings can be measured and events can be anticipated. Using such a process can allow for setting up of actions in anticipation of their occurrence, further enhancing the process.

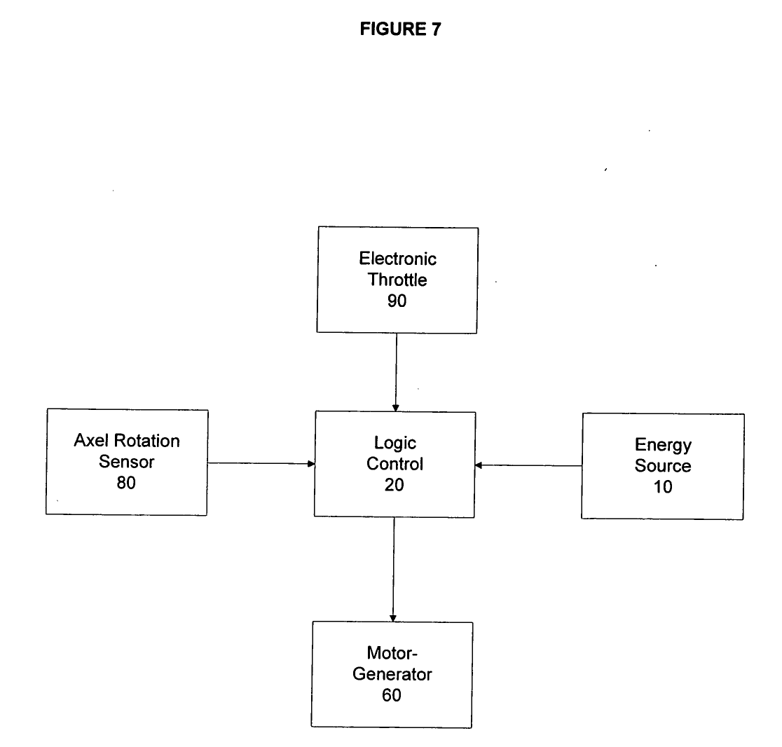

As a further example, an embodiment where the Motor-Generator is caused to go into a No-Rotation mode will now be described by reference to FIG. 7. This can be quite desirable for safety purposes when personnel must go into the engine room and might encounter the motor or propeller shaft. A control switch to activate this mode would be advantageously located both at the helm station and in the engine room. A skilled artisan will no doubt recognize many other applications where this mode would be advantageous, such as in performing maintenance on an HVAC system or for use as a parking break in a land-based vehicle.

In one possible embodiment the user could activate a button on the Electronic Throttle 90 labeled, for example, “NR” (no rotation), or “Motor Stop”. This would send a signal to Logic Control 20 for it to cause Motor-Generator to maintain a no-rotation state. As verification of this no-rotation state, an Axel Rotation Sensor 80 would provide information to Logic Control 20. If Axel Rotation Sensor 80 information indicates the axel is rotating, Logic Control 20 will send a signal to Energy Source 10 to apply energy to oppose the rotation. Logic Control 20 will continually monitor input information from Axel Rotation Sensor 80 and adjust energy from Energy Source 10 to Motor-Generator 60 on a moment-by-moment basis to maintain this No-Rotation state.

Another possible means for achieving this No-Rotation mode could be to apply equal and opposing energy to poles of an electric motor causing it to be locked into position. The actual controlling of the motor is secondary to the overall automation algorithms that would receive input signals from various sensors and thru logic control, cause the shaft to maintain a no-rotation state.

Further adaptations of this Automation System could include inputs from automatic navigation systems, wave and wind sensors and solar energy level sensors. A multi-motored vessel could be made to steer a designated heading or course and best take advantage of wind, wave and solar conditions to achieve this course. A vessel could employ a communications system whereby the Logic Control would notify the operator of conditions using signals such as lights, audio or radio communications. The operator could then communicate directly with the Logic Control to ascertain the situation and acknowledge suggested solutions or courses of action to be taken. A vessel could be made to maintain station through the use of GPS inputs and orient the vessel into the prevailing current and or wind and use the drag on the propeller to, thru the use of Logic Control, exert drag on the current and thereby maintain GPS position. Thru the use of algorithms written into the Logic Control and through the use of adaptive learning systems, a vessel so equipped could maintain itself for an indefinite amount of time, and with minimal or no costly fuel input.

Still further, FIG. 7 illustrates an embodiment of the invention in which an energy storage element, typically one or more batteries, is not present. As a general matter, the described embodiments of the invention need not necessarily include such an energy storage element. The skilled artisan will appreciate, for example, vehicles, and in particular marine vehicles including sail boats, could apply various principles of the invention using an electric motor for propulsion and at least one electrical energy source supplying electricity to the motor as an electrical energy user.

The invention being thus disclosed and illustrative embodiments depicted herein, further variations and modifications of the invention will occur to those skilled in the art. All such variations and modifications are considered to be within the scope of the invention, as defined by the claims appended hereto and equivalents thereof.

What is claimed is:

1. An automated energy generating and energy using system comprising:
at least one electric energy user, each electric energy user having a sensor for determining an amount of energy used;
at least one electric energy source, each electric energy source have a sensor for determining an amount of energy provided;
at least one electric energy storage element, each electric energy storage element having a sensor for determining an amount of energy available in the storage element;
a controller operatively connected to each energy source, energy storage element and sensor, the controller configured to control a level of operation of the at least one source of energy based upon at least the amount of energy used and the amount of energy available in the storage element.

2. The system of claim 1, wherein the at least one electric energy user includes an electric motor.

3. The system of claim 2, wherein the electric motor also operates as a generator and is an energy source in the system.

4. The system of claim 1, wherein the energy sources include an on-demand, consumable energy source.

5. The system of claim 4, wherein the energy sources further include a renewable energy source.

6. The system of claim 1, further comprising a throttle configured to allow a user to control a level of operation of at least one energy user in the system, the throttle including a sensor indicating the throttle position to the controller, and the controller controlling a level of operation of at least one source of energy based upon at least the position of the throttle.

7. The system of claim 6, wherein the controller controls a level of operation of at least one energy user in the system by adjusting a position of the throttle.

8. The system of claim 1, wherein the energy storage includes one or more batteries and a battery charging unit.

9. The system of claim 8, wherein the controller controls a level of operation of at least one energy source based upon at least an amount of energy being used or provided by the battery and the battery charging unit and an amount of energy available in the one or more batteries.

10. The system of claim 9, wherein the energy sources include an on-demand, consumable energy source and controlling the level of operation of at least one energy source including turning the on-demand, consumable energy source on and off.

11. The system of claim 10, wherein the system includes a plurality of electric energy sources and the controller is configured to control a level of operation of the battery charger and each energy source to provide a bulk charge, an acceptance charge, and a float charge based upon the amount of energy available in the energy storage element.

12. The system of claim 1, wherein the controller includes a memory for storing historical inputs from the sensors and is configured to provide adaptive control to the controlling the level of operation of the at least one source of energy.

13. The system of claim 12, wherein the system further includes a throttle configured to allow a user to control a level of operation of at least one energy user in the system, the throttle including a sensor indicating the throttle position to the controller, and the controller controlling a level of operation of at least one source of energy based upon at least the position of the throttle, the controller further being configured to control a level of operation of at least one energy user in the system by adjusting a position of the throttle, the memory storing historical positions of the throttle and applying adaptive control to control the level of operation of at least one energy source and the position of the throttle.

14. A vehicle having an automated energy generating and energy using system comprising:
at least one electric energy user, each electric energy user having a sensor for determining an amount of energy used and the at least one electric energy user including at least one electric motor used to propel the vehicle;
at least one electric energy source, each electric energy source having a sensor for determining the amount of energy provided;
at least one electric energy storage element, each electric energy storage element having a sensor for determining an amount of energy available in the storage element;
a controller operatively connected to each energy source, energy storage element and sensor, the controller configured to control a level of operation of the at least one source of energy based upon at least the amount of energy used and the amount of energy available in the storage element.

15. The system of claim 14, further comprising a throttle configured to allow a user to control a level of operation of the at least one electric motor, the throttle including a sensor indicating the throttle position to the controller, and the controller controlling a level of operation of at least one source of energy based upon at least the position of the throttle.

16. The system of claim 15, wherein the controller controls a level of operation of the at least one electric motor by adjusting a position of the throttle.

17. The system of claim 16, further comprising a speed sensor sensing a speed of the vehicle and communicating a signal representative of the speed to the controller.

18. The system of claim 17, wherein the controller is configured to adjust the throttle so as to maintain a maximum efficient velocity of the vehicle.

19. The system of claim 16, wherein the controller includes a memory for storing historical inputs from the sensors and is configured to provide adaptive control to the controlling the level of operation of the at least one source of energy and the position of the throttle.

20. The system of claim 17, wherein the controller is configured to adjust the throttle so as to maintain a no-drag state of the electric motor of the vehicle.

21. The system of claim 14, wherein the electric motor also operates as a generator and is an energy source in the system.

22. The system of claim 14, wherein the energy sources include an on-demand, consumable energy source.

23. The system of claim 21, wherein the energy sources further include a renewable energy source.

24. The system of claim 23, wherein the energy storage includes one or more batteries and a battery charging unit.

25. The system of claim 24, wherein the controller controls a level of operation of at least one energy source based upon at least an amount of energy being used or provided by the battery and the battery charging unit and an amount of energy available in the one or more batteries.

26. The system of claim 25, wherein controlling the level of operation of at least one energy source includes turning the on-demand, consumable energy source on and off.

27. The system of claim 26, wherein the controller is configured to control a level of operation of the battery charger and each energy source to provide a bulk charge, an acceptance charge, and a float charge based upon the amount of energy available in the energy storage element.

28. A method of controlling an automated energy generating and energy using system having at least one electric energy user having a sensor determining an amount of energy used, at least one electric energy source having a sensor for determining the amount of energy provide, at least one electric energy storage element having a sensor for determining an amount of energy available from the storage element, and a controller operatively connected to each energy source, energy storage element and sensor, comprising:
querying by the controller of each energy user sensor to determine the amount of energy being used in the system;
querying by the controller of each energy source sensor to determine the amount of energy being provided in the system;
querying by the controller of the storage element sensor to determine the amount of energy available in the storage element; and
adjusting by the controller of a level of operation of at least one energy source.

29. The method of claim 28, wherein the system includes a throttle configured to allow a user to control a level of operation of at least one energy user in the system, the throttle including a sensor indicating the throttle position to the controller, and the controller controls a level of operation of at least one source of energy based upon at least the position of the throttle.

30. The method of claim 29, wherein the controller controls a level of operation of at least one energy user in the system by adjusting a position of the throttle.

31. The method of claim 28, wherein the energy storage includes one or more batteries and a battery charging unit.

32. The method of claim 31, wherein the controller controls a level of operation of at least one energy source based upon at least an amount of energy being used or provided by the battery and the battery charging unit and an amount of energy available in the one or more batteries.

33. The system of claim 32, wherein the energy sources include an on-demand, consumable energy source and controlling the level of operation of at least one energy source includes turning the on-demand, consumable energy source on and off.

34. The method of claim 33, wherein the system includes a plurality of electric energy sources and the method further comprises adjusting by the controller of a level of operation of the battery charger and each energy source to provide a bulk charge, an acceptance charge, and a float charge based upon the amount of energy available in the energy storage element.

35. The method of claim 28, wherein the controller includes a memory for storing historical inputs from the sensors and is configured to provide adaptive control to the controlling the level of operation of the at least one source of energy.

36. The method of claim 35, wherein the system further includes a throttle configured to allow a user to control a level of operation of at least one energy user in the system, the throttle including a sensor indicating the throttle position to the controller, and the controller controlling a level of operation of at least one source of energy based upon at least the position of the throttle, the method further comprising adjusting by the controller of a level of operation of at least one energy user in the system by adjusting a position of the throttle, the memory storing historical positions of the throttle and applying adaptive control to control the level of operation of at least one energy source and the position of the throttle.

37. The method of claim 29, wherein the at least one electric energy user includes an electric motor.

38. The method of claim 37, wherein the electric motor also operates as a generator and is an energy source in the system.

39. The method of claim 37, wherein the controller controls a level of operation of the at least one electric motor by adjusting a position of the throttle.

40. The method of claim 39, wherein the system is a vehicle and the at least one electric motor provides propulsion for the vehicle.

41. The method of claim 40, wherein the vehicle further includes a speed sensor sensing a speed of the vehicle and communicating a signal representative of the speed to the controller.

42. The method of claim 41, further comprising adjusting by the controller of the throttle so as to maintain a maximum efficient velocity of the vehicle.

43. The method of claim 41, further comprising adjusting by the controller of the throttle so as to maintain a no-drag state of the electric motor of the vehicle.

44. An automated energy generating and energy using system for use in a vehicle comprising:
at least one electric energy user, each electric energy user having a sensor for determining an amount of energy used, the at least one energy user including an electric motor providing propulsion;
at least one electric energy source, each electric energy source have a sensor for determining an amount of energy provided;
a controller operatively connected to each energy source, and sensor, the controller configured to control a level of operation of the at least one source of energy based upon at least the amount of energy used.

45. The system of claim 44, further comprising a throttle configured to allow a user to control a level of operation of the at least one electric motor, the throttle including a sensor indicating the throttle position to the controller, and the controller controlling a level of operation of at least one source of energy based upon at least the position of the throttle.

46. The system of claim 45, wherein the controller controls a level of operation of the at least one electric motor by adjusting a position of the throttle.

47. The system of claim 46, further comprising a speed sensor sensing a speed of the vehicle and communicating a signal representative of the speed to the controller.

48. The system of claim 47, wherein the controller is configured to adjust the throttle so as to maintain a maximum efficient velocity of the vehicle.

49. The system of claim 47, wherein the controller is configured to adjust the throttle so as to maintain a headway of the vehicle.

50. The system of claim 47, wherein the controller is configured to maintain a zero rotation state of the electric motor.

51. The system of claim 46, wherein the controller includes a memory for storing historical inputs from the sensors and is configured to provide adaptive control to the controlling the level of operation of the at least one source of energy and the position of the throttle.

52. The system of claim 47, wherein the controller is configured to adjust the throttle so as to maintain a no-drag state of the electric motor of the vehicle.

53. The system of claim 44, wherein the electric motor also operates as a generator and is an energy source in the system.

54. The system of claim 44, wherein the energy sources include an on-demand, consumable energy source.

55. The system of claim 54, wherein the energy sources further include a renewable energy source.
